(19) United States
(12) Patent Application Publication
(10) Pub. No.: US 2026/0064957 A1
(43) Pub. Date: Mar. 5, 2026

(54) METHOD, APPARATUS, MEDIUM, AND PROGRAM PRODUCT FOR GENERATING COPYWRITING OUTLINE

(71) Applicant: DOUYIN VISION CO., LTD., Beijing (CN)

(72) Inventors: Haoyun DONG, Beijing (CN); Yifan LI, Beijing (CN); Meng LI, Beijing (CN)

(21) Appl. No.: 19/257,297

(22) Filed: Jul. 1, 2025

(30) Foreign Application Priority Data
Sep. 3, 2024 (CN) 202411230837.5

(51) Int. Cl. G06F 40/186; G06F 40/169; G06F 40/194

(52) U.S. Cl. CPC G06F 40/186; G06F 40/169; G06F 40/194

(57) ABSTRACT

Embodiments of the present disclosure provide a method for generating a copywriting outline, a device, a medium and a program product. The method includes determining an outline template of a copywriting based on a type label of the copywriting, where the outline template includes an outline module corresponding to the type label. In addition, the method further includes generating a copywriting outline of the copywriting based on the determined outline template and user input content.

### CROSS-REFERENCE TO RELATED APPLICATION(S)

This application claims priority to Chinese Application No. 202411230837.5 filed on Sep. 3, 2024, the disclosure of which is incorporated herein by reference in its entirety.

### FIELD

The present disclosure generally relates to the field of computers, and more specifically, to a method for generating a copywriting outline, an electronic device, a computer-readable storage medium, and a computer program product.

### BACKGROUND

A copywriting outline is a preliminary design scheme for implementing systematic planning and structural layout of copywriting content, aiming at clarifying the core information, logical structure, and expression form of the copywriting. The copywriting outline may help the creator to create in an orderly manner and ensure high consistency between the copywriting and the content of the outline, so as to better convey the theme and make the reader easier to understand and accept the content of the copywriting.

The text generation capability of artificial intelligence (AI) plays a role in various application fields and can produce various kinds of application text content. It is very meaningful to use artificial intelligence to assist the copywriting creator to generate the copywriting outline to improve the creation experience of the author.

### SUMMARY

According to example embodiments of the present disclosure, a method for generating a copywriting outline, an electronic device, a computer storage medium, and a computer program product are provided.

In a first aspect of the present disclosure, a method for generating a copywriting outline is provided, including: determining an outline template of a copywriting based on a type label of the copywriting, where the outline template includes an outline module corresponding to the type label; and generating a copywriting outline of the copywriting based on the determined outline template and user input content.

In a second aspect of the present disclosure, an electronic device is provided, including: at least one processing unit; and at least one memory, the at least one memory being coupled to the at least one processing unit and stores instructions executable by the at least one processing unit, the instructions, when executed by the at least one processing unit, causing the electronic device to execute the method according to the first aspect of the present disclosure.

In a third aspect of the present disclosure, a computer-readable storage medium is provided, on which a computer program is stored, and the computer program, when executed by a processor, causes the device to implement the method according to the first aspect of the present disclosure.

In a fourth aspect of the present disclosure, a computer program product is provided, on which a computer program is stored, and the computer program, when executed by a processor, implements the method according to the first aspect of the present disclosure.

The summary section is provided to introduce a series of concepts in a simplified form, which will be further described in the following detailed description. The summary section is not intended to identify key features or necessary features of the present disclosure, nor is it intended to limit the scope of the present disclosure. Other features of the present disclosure will become easy to understand through the following description.

### BRIEF DESCRIPTION OF THE DRAWINGS

The above and other features, advantages, and aspects of various embodiments of the present disclosure will become more apparent with reference to the following detailed description taken in conjunction with the drawings. In the drawings, the same or similar reference numerals represent the same or similar elements, where:

FIG. 1 shows a schematic diagram of a system for generating a copywriting outline according to an embodiment of the present disclosure;

FIG. 2 shows a flowchart of a method for generating a copywriting outline according to an embodiment of the present disclosure;

FIG. 3 shows a schematic diagram of a process of generating a novel outline according to an embodiment of the present disclosure;

FIGS. 4A-4D show schematic diagrams of interaction interfaces in a process of generating a novel outline of a method for generating a novel outline according to an embodiment of the present disclosure;

FIGS. 5A-5B show schematic diagrams of an exemplary process of displaying content of one or more summaries to a user by the method for generating a novel outline according to an embodiment of the present disclosure;

FIG. 6 shows a flowchart of an exemplary training method of a model according to some embodiments of the present disclosure;

FIG. 7 shows a schematic block diagram of an example apparatus according to some embodiments of the present disclosure; and

FIG. 8 shows a block diagram of an example device that can be used to implement the embodiments of the present disclosure.

### DETAILED DESCRIPTION OF EMBODIMENTS

Embodiments of the present disclosure will be described in more detail below with reference to the drawings. While some embodiments of the present disclosure are shown in the drawings, it should be understood that the present disclosure can be implemented in various forms and should not be interpreted as limited to the embodiments set forth herein, rather, these embodiments are provided for a more thorough and complete understanding of the present disclosure. It should be understood that the drawings and embodiments of the present disclosure are only for illustrative purposes and are not intended to limit the protection scope of the present disclosure.

A copywriting outline is a preliminary design scheme for implementing systematic planning and structural layout of copywriting content, aiming at clarifying the core information, logical structure and expression form of the copywriting. The copywriting outline can help the creator to create in an orderly manner and ensure the high consistency between the copywriting and the content of the outline to better convey the theme and make the reader easier to understand and accept the content of the copywriting.

Currently, artificial intelligence technology is applied to various application scenarios. With the continuous development of models and the continuous emergence of large-scale data sets, artificial intelligence technology has also made great development and progress in generating multimedia content (for example, text, image, audio, etc.), and has brought a lot of convenience and innovation to people's work and life. Using artificial intelligence to assist copywriting generation usually requires multiple adjustments of prompts to obtain a copywriting outline whose content and structure meet the requirements.

In view of this, an embodiment of the present disclosure provides a method for generating a copywriting outline. The method may include: determining an outline template of a copywriting based on a type label of the copywriting, and generating a copywriting outline of the copywriting based on the determined outline template and user input content. By adopting the method of the embodiment of the present disclosure, it is possible to provide a copywriting outline for a user when the user creates a copywriting, thereby improving the creation experience of the user.

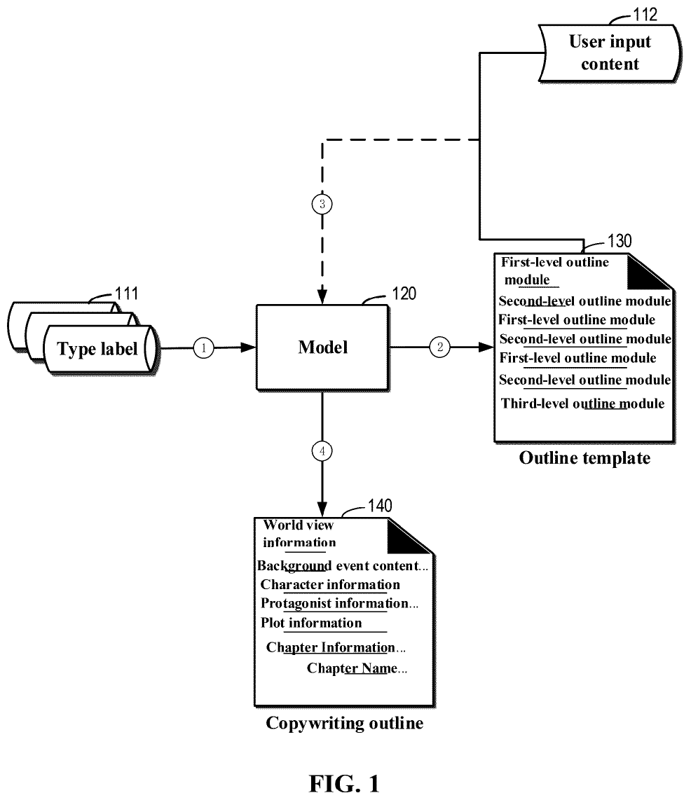

The embodiments of the present disclosure will be further described in detail below with reference to the drawings, where FIG. 1 shows a schematic diagram of a system for generating a copywriting outline according to an embodiment of the present disclosure. As shown in FIG. 1, a model 120 is usually deployed in one or more computer devices and is capable of generating an output related to input content according to the input of the model. The computing device may include, but is not limited to, a personal computer, a server computer, a handheld or laptop device, a mobile device (such as a mobile phone, a personal digital assistant (PDA), a media player, etc.), a multi-processor system, a consumer electronic product, a wearable electronic device, a smart home device, a small computer, a large computer, an edge computing device, a distributed computing system including any of the above systems or devices, and the like. In the example of FIG. 1, the model 120 may generate a copywriting outline for the copywriting according to the type label of the copywriting and user input content.

In some embodiments, an application (for example, a client program, a web application, etc.) that can invoke the model 120 can be installed or accessed on one computing device, and the model 120 may be deployed on another computing device, and the two computing devices may communicate over a network. The copywriting outline of the copywriting can be generated by the model 120 in the other computing device based on the type label of the copywriting and the user input content through the application in one computing device. In some embodiments, the model 120 may be split into multiple sub-models according to actual requirements, and each sub-model may be deployed in a corresponding computing device to implement distributed deployment, for example, to support a large-scale model. The copywriting outline of the copywriting may be generated by the model 120 with distributed deployment based on the type label of the copywriting and the user input content by the application in one computing device. In some embodiments, with the lightweight of the model 120, the model 120 may be deployed locally on the computing device that installs or accesses the application, so that the request of the user can be responded to more quickly and the response information can be generated.

In some embodiments, the copywriting may be a paragraph or paragraphs of text used to represent information, such as, but not limited to, advertisement, news plan, novel story, and the like. Different types of copies may have different architectures. For example, a fantasy novel shows an imaginative story by constructing a unique fictional world and rich character relationships, as well as fantasy plots and events. However, an urban romance novel pays more attention to the description of real life, and reflects the challenges and problems in real life through real characters and complex plot structures. Therefore, the fantasy novel and the urban romance novel may be different in plot arrangement, character creation, and background setting. Specifically, the structural features of the fantasy novel include setting a unique world view, constructing a self-contained fictional world, constructing rich character relationships, including good and evil forces, family disputes, etc., forming a complex character network, and creating fantasy plots and events, including elements such as adventure, battle, growth, etc., to form a story with ups and downs. The structural features of the urban romance novel include creating real characters, depicting characters with a sense of reality, including their occupations, family backgrounds, etc., constructing a complex plot structure, promoting the development of the story through a series of events, showing the growth and change of characters, highlighting the reflection and discussion of real problems, such as social problems, interpersonal relationships, etc., increasing the practical significance and social value of the novel. Therefore, in some embodiments, the computing device can determine the outline template 130 of the copywriting by the model 120 based on the type label 111 of the copywriting. The outline template 130 includes an outline module corresponding to the type label 111, so that the outline module generated based on different type labels can have different structural features, which may be more in line with the copywriting type defined by the type label 111. In some embodiments, the model 120 may be a large language model, which may generate various text contents, such as, but not limited to, an outline template, a copywriting outline, etc., after training. The type label 111 may include, but is not limited to, a label used to describe the type of the copywriting in terms of theme, characters, plot, etc. (such as a label with the text “urban romance”).

In some embodiments, the computing device may generate the copywriting outline 140 of the copywriting based on the determined outline template 130 and the user input content 112. The copywriting outline 140 can describe at least one of the core information, the logical structure, and the expression form of the copywriting, and if the user is satisfied with the generated copywriting outline 140, the computing device can also save the generated copywriting.

The system of the method for generating a copywriting outline according to the embodiments of the present disclosure may provide a copywriting outline for a user when the user creates a copywriting, thereby improving the creation experience of the user.

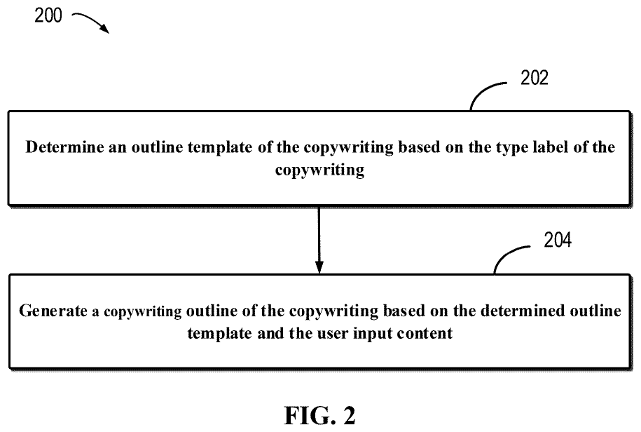

The flow of the method for generating a copywriting outline according to the embodiments of the present disclosure will be described below with reference to FIG. 2. FIG. 2 shows a flowchart of a method 200 for generating a copywriting outline according to an embodiment of the present disclosure. The method 200 can be executed at any suitable computing device. It should be understood that the numbering in the flowchart of the method 200 does not represent the sequence of execution of these steps, and some or all of these steps may be executed in parallel, or the execution sequence may be exchanged with each other, which is not limited by the present disclosure. Additionally, the method 200 in FIG. 2 may further include additional steps not shown and/or may omit the shown steps, and the scope of the present disclosure is not limited in this respect.

As shown in FIG. 2, in block 202, the computing device may generate an outline template of the copywriting by a model based on a type label of the copywriting. In some embodiments, the outline template includes an outline module corresponding to the type label, and different outline templates can be generated based on different type labels to conform to the structural characteristics of the copywriting defined by the type labels. In block 204, the computing device generates a copywriting outline of the copywriting by the model based on the outline template generated in block 202 and the user input content. The copywriting may be a paragraph or paragraphs of text used to represent information, such as, but not limited to, advertisement, news plan, novel story, and the like. The copywriting outline may describe at least one of the core information, the logical structure, and the expression form of the copywriting. Therefore, the generated copywriting outline may help the creator to create in an orderly manner and ensure the high consistency between the copywriting and the content of the outline to better convey the theme and make the reader easier to understand and accept the content of the copywriting. In some embodiments, the computing device may install or access an application that may invoke the model to automatically generate a copywriting outline of the copywriting for the user based on the label of the copywriting and the user input content. It is possible to simplify the operation of the user and improve the fitness between the generated copywriting outline and the requirements of the user.

In block 202, the user may define the copywriting type (for example, fantasy or urban romance) through the type label of the copywriting, and the computing device may call the model to generate the outline template based on the type label of the copywriting. In some embodiments, the computing device can display a plurality of type labels in an interface of an application for the user to select, and determine one or more type labels of the copywriting from the displayed type labels according to the user's selection. In some embodiments, the computing device may generate a first prompt for the model based on the type label of the copywriting, and generate the outline template of the copywriting by the model based on the first prompt.

In block 204, the computing device may generate the copywriting outline of the copywriting based on the outline template determined in block 202 and the user input content. In some embodiments, the computing device may generate a second prompt for the model based on the outline template and the user input content, and generate the copywriting outline of the copywriting by the model based on the second prompt. In some embodiments, the computing device extracts a keyword of the user input content and generates the second prompt based on the extracted keyword and the outline template. In some embodiments, the computing device may also generate the second prompt based on the keyword extracted from the copywriting, the user input content, and the type label of the copywriting.

Therefore, according to the method for generating a copywriting outline in the embodiment of the present disclosure, it is possible to generate the copywriting outline of the copywriting based on the label of the copywriting and the user input content to provide the copywriting outline for the user when the user creates the copywriting, thereby improving the user experience.

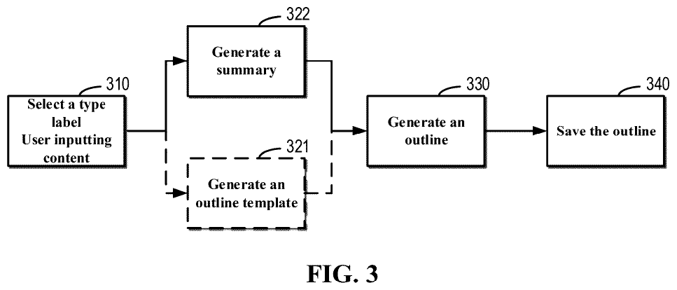

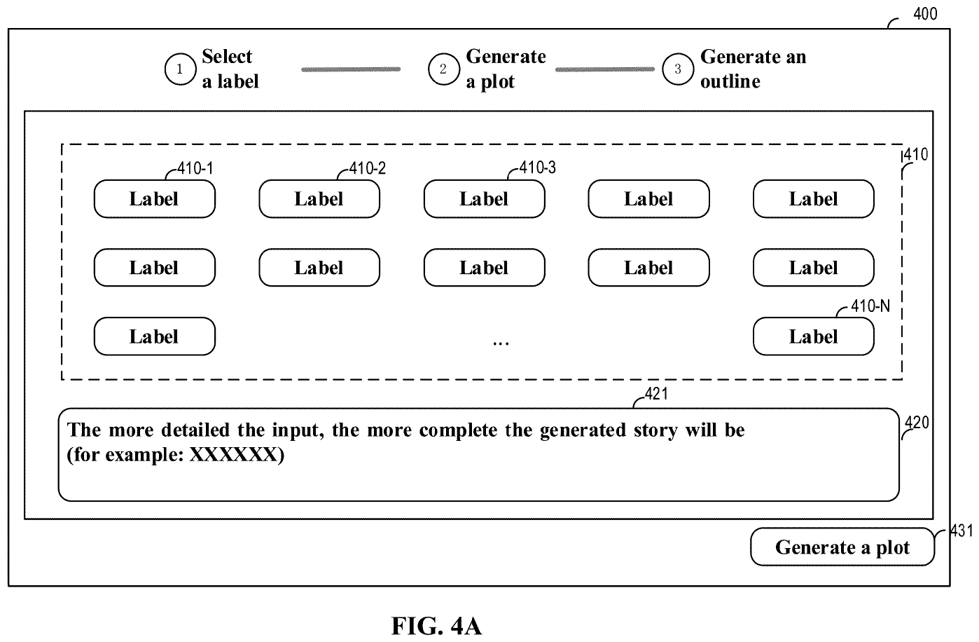

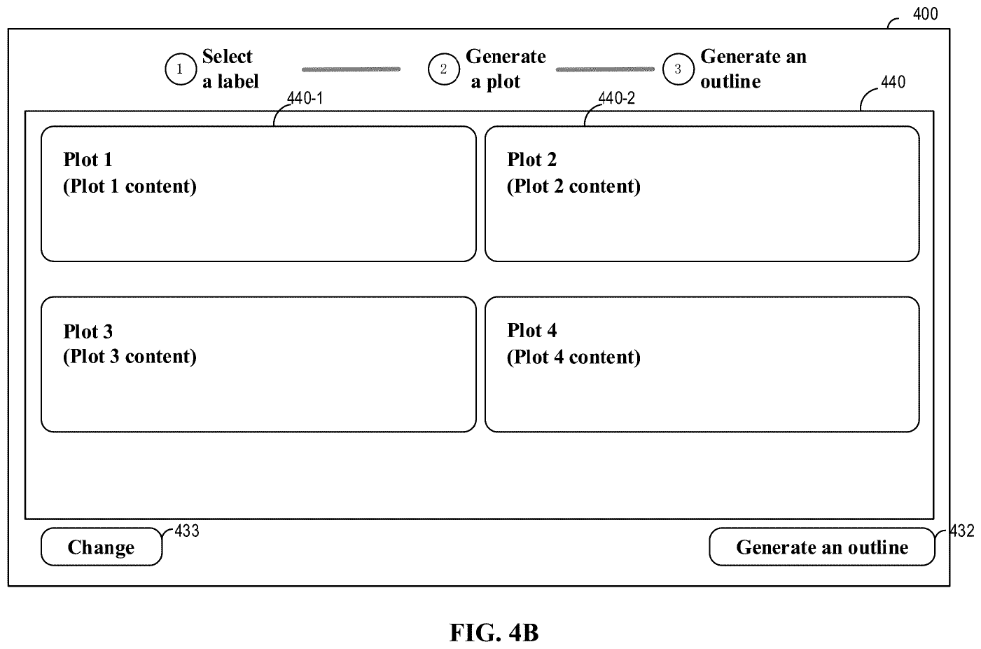

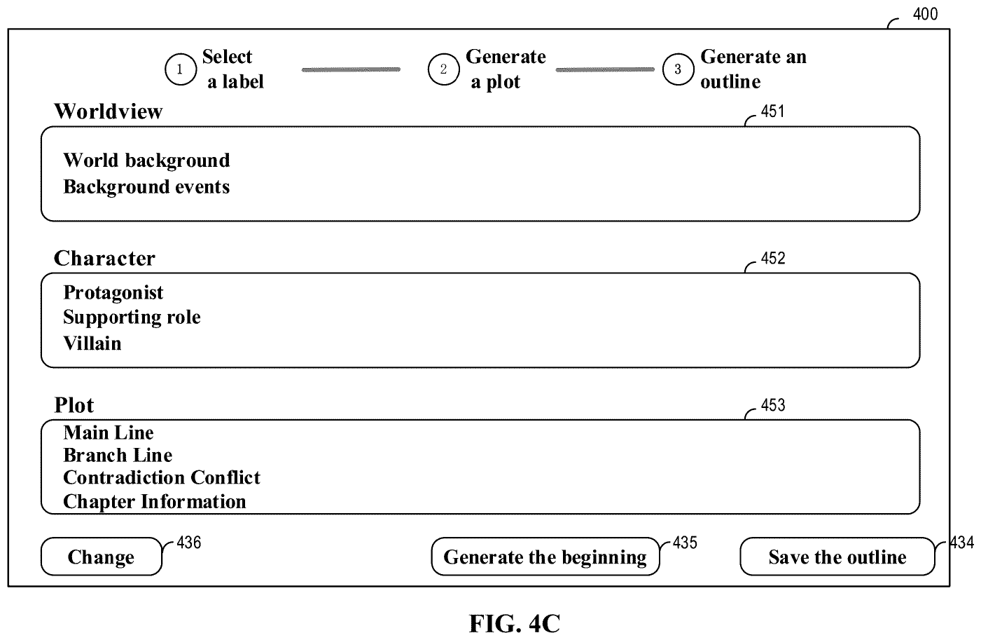

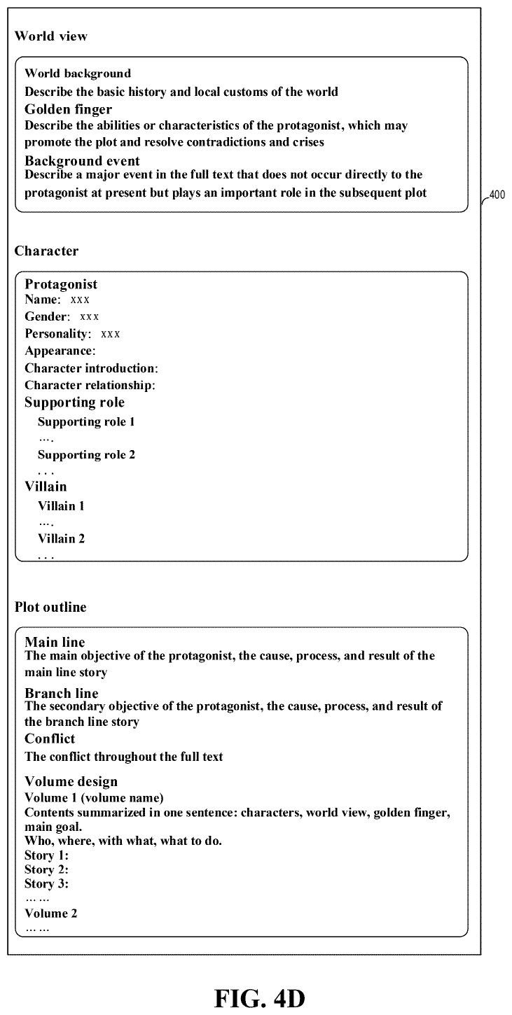

The process of the method for generating a novel outline will be described below with reference to FIG. 3 and FIG. 4. FIG. 3 shows a schematic diagram of a process of generating a novel outline according to an embodiment of the present disclosure. FIGS. 4A-4D show schematic diagrams of interaction interfaces 400 in a process of generating a copywriting outline of an application installed on a computing device for invoking the model 120 according to an embodiment of the present disclosure. It may be understood that the interaction interfaces in FIG. 4A-4D are only schematic, and the interaction interface 400 may be adapted to a corresponding type and displayed accordingly according to different types of computing devices. Additionally, although FIG. 3 and FIGS. 4A-4D show the process of the method for generating a novel outline, this is only exemplary, and the method may support the generation of copywriting outlines of different types of copies.

As shown in FIG. 3, the process of generating a novel outline in the embodiment of the present disclosure includes four stages. In block 310, the user selects a type label of the copywriting and inputs a description about the copywriting. The stage represented by block 321 is invisible in the interaction interface 400, and is represented by a dashed box. In block 321, the model generates an outline template of the copywriting for the user according to the type label selected by the user in block 310. In block 322, the model generates one or more summaries for the user according to the type label selected by the user in block 310 and the user input content, and the user selects a target summary from the generated summaries. In block 330, the model generates a copywriting outline for the user according to the outline template generated in block 321 and the target summary selected in block 322. If the user is satisfied with the generated outline, the generated outline is saved. In block 340, after the outline is saved for the user, the saved outline is displayed to the user completely.

FIG. 4A shows a schematic diagram of an interface corresponding to block 310 in FIG. 3. The interface 400 in FIG. 4A may include a label area 410, a text input box 420, and a button 431. A plurality of type labels, such as label 410-1, label 410-2, label 410-3 . . . 410-N, etc., are displayed in the label area 410, where N represents the number of displayed labels. Each label may be associated with a type of the novel, and the labels in the label area 410 may be selected to indicate that the user wants the novel to have the type features corresponding to the labels. In some embodiments, the user only selects a certain label in the label area 410. Alternatively, or additionally, the user may also select a plurality of labels in the label area 410 at the same time. In some embodiments, the type labels may be set to multiple levels, for example, three levels. Specifically, the first-level type label is the highest-level type label, which may be used to define the top-level structure of the outline template, the second-level type label may be set for different first-level type labels to define the middle-level structure of the outline template, and the third-level type label may also be set for different second-level type labels to define the bottom-level structure of the outline template. The outline template generated based on the type label may include a first-level outline module corresponding to the first-level type label, and the first-level outline module may further include a second-level outline module corresponding to the second-level label under the corresponding first-level type label, and the second-level outline module may further include a third-level outline module corresponding to the third-level label under the corresponding second-level label. Therefore, the user may complete the definition of the structure of the outline template from the top to the bottom by selecting rich hierarchical type labels. For example, the first-level outline module may include, but is not limited to, at least one of world view information, character information, and plot information. The main content of the world view information, the character information, and the plot information of the novel outline template may be defined by the selected first-level type label (for example, urban romance, fantasy, etc.). By selecting the second-level type label (for example, the second-level label of urban romance, such as extortion, campus literature, road literature, etc.), the world background and the background world of the world view information, the protagonist information, the supporting role information and the villain information of the character information, and the main line plot, the branch line plot, the contradiction conflict and the chapter information of the plot information may be further defined. The name, gender, character, appearance, character introduction and task relationship of the protagonist, supporting role and villain information, and the chapter name, chapter introduction and one or more chapter stories of the chapter information are defined by selecting the third-level type label (for example, the third-level label of campus literature, such as loyal dog, cat-like, yandere, loser, etc.). If there is no label that the user feels suitable among the labels displayed in the label area 410, the user may also create a custom type label by adding a label, and display the added custom label in the label area 410.

The text input box 420 may be used to receive and display the user's text input, or the text input box 420 may also receive the user's voice and convert it into a text input for display. The user may input any description of the novel through the text input box 420. The button 431 is used to trigger the computing device to enter the stages of block 321 and block 322, in block 321, the computing device generates a corresponding outline template based on the label selected in the label area 410, and in block 322, the computing device generates a plurality of novel plots based on the label selected in the label area 410 and the user input content in the text input box 410. In block 321, the computing device generates a first prompt for the model based on the label selected in the label area 410, and invokes the model with the generated first prompt as the input of the model to obtain the outline template of the copywriting.

FIG. 4B shows a schematic diagram of an interface corresponding to block 321 in FIG. 3. In block 321, the computing device may obtain the label selected in the label area 410 and the user input content in the text input box 420, generate a second prompt for the model 120, and invoke the model 120 with the generated second prompt as the input of the model 120 to obtain a plurality of summaries. The computing device presents the summaries generated by the model 120 in the interface 400. In order to generate the novel plots that are more in line with the requirements of the user, the model 120 may randomly generate a plurality of different summaries for the user, and the generated summaries have differences in aspects not defined by the selected label and the user input content. As shown in FIG. 4B, the interface 400 includes a summary area 440, a button 432, and a button 433. The summary area 440 includes a plurality of text boxes for displaying the generated summaries, such as a text box 440-1 and a text box 440-2. The content of one summary is displayed in each text box, and the text box in the summary area 410 may be selected to indicate that the user selects the summary displayed in the text box. If the user is not satisfied with all the summaries displayed in the text boxes in the summary area 440, the computing device may be triggered by the button 433 to regenerate the summaries based on the label selected in block 310 and the user input content. In response to the triggering of the button 433, the computing device generates a new second prompt for the model based on the label selected in block 310 and the user input content, invokes the model with the generated second prompt as the input of the model to obtain one or more new summaries, and updates and displays the generated new summaries in the text boxes in the summary area. If the user selects a satisfactory target summary in the summary area, the computing device may be triggered by the button 432 to enter the stage of block 330, and in block 330, the computing device generates a novel outline for the user based on the summary selected in the summary area 440.

FIG. 4C shows a schematic diagram of an interface corresponding to block 330 in FIG. 3. In response to the triggering of the button 432, the computing device obtains the summary selected in the summary area 440, generates a third prompt for the model, invokes the model with the generated third prompt as the input of the model to obtain a novel outline, and presents the generated novel outline in the interface 400. The novel outline may include world view information, character information, and plot information of the novel. As shown in FIG. 4C, the interface 400 includes a world view area 451, a character area 452, a plot area 453, a button 434, a button 435, and a button 436. The world view area 451 includes a text box for displaying the world view information of the novel outline, the character area 452 includes a text box for displaying the character information, and the plot area includes a text box for displaying the plot information. The world view information may include, but is not limited to, at least one of a world background and a background event, the character information may include, but is not limited to, at least one of protagonist information, supporting role information, and villain information, and the plot information may include, but is not limited to, at least one of a main line plot, a branch line plot, a contradiction conflict, and chapter information. The protagonist information, the supporting role information, and the villain information may all include, but are not limited to, at least one of a name, a gender, a character, an appearance, a character introduction, and a task relationship. The chapter information may include, but is not limited to, at least one of a chapter name, a chapter introduction, and one or more story introductions. The user may browse and edit the content in each text box, and if the user is not satisfied with the generated novel outline, the user may trigger the computing device to generate a new novel outline for the user based on the target summary selected in block 320 through the button 436. In response to the triggering of the button 436, the computing device generates a new third prompt for the model based on the target summary selected in block 320, invokes the model with the generated third prompt as the input of the model to obtain the new novel outline. If the user is satisfied with the generated novel outline, the user may trigger the computing device to enter the stage of block 340 through the button 434, and in the stage of block 340, the computing device saves the generated novel outline for the user, and the user may call up the saved novel outline when writing the novel to guide the writing of the novel, ensuring the high consistency between the copywriting and the content of the outline, so as to better convey the theme and make the reader easier to understand and accept the content of the copywriting. The user may also trigger the computing device to generate a novel beginning based on the generated novel outline through the button 435, to help the user quickly enter the writing stage of the novel. In response to the triggering of the button 435, the computing device generates a fourth prompt for the model based on the generated novel outline, invokes the model with the generated fourth prompt as the input of the model to obtain a novel beginning corresponding to the novel outline. In response to the triggering of the button 434, the computing device enters the stage of block 340, and in block 340, the computing device saves the generated novel outline and displays the complete content of the novel outline for the user.

FIG. 4D shows a schematic diagram of an interface corresponding to block 340 in FIG. 3. In response to the saving of the generated novel outline, the computing device presents the entire content of the saved novel outline in the interface 400. As shown in FIG. 4D, the content of the novel outline of the fantasy novel may include world view, characters, and plot outline. The world view includes a world background, a golden finger, and a background event. The world background describes the basic history and customs of the world, the golden finger describes the abilities or characteristics of the protagonist, and the energy or characteristics may play a role in promoting the plot and solving contradictions and crises. The background event describes a full-text event that does not directly occur to the protagonist at present, but plays an important role in the subsequent plot. The characters include one or more protagonists, one or more supporting roles, and one or more villains, and the information of each character includes a name, a gender, a character, an appearance, a character introduction, a character relationship, and the like. The plot outline includes a main line, a branch line, a contradiction conflict, and chapter information. The main line describes the main goal of the protagonist, the cause, process, and result of the main line story, the branch line describes the secondary goal of the protagonist, the cause, process, and result of the branch line story, the contradiction conflict describes the contradiction throughout the full text, and the chapter information describes the volume design of the novel. For each volume, the volume name, the volume content summarized in one sentence (for example, who does what by what in what place), and one or more stories are described. It may be understood that the content of the novel outline shown in FIG. 4D is exemplary, and for different types of copies, the method may support the generation of copywriting outlines with different architectures, and the user may obtain the copywriting outline with a high matching degree between the architecture and the copywriting type without multiple inputs and adjustments of prompts.

The interaction interfaces in the process of the method for generating a novel outline according to the embodiments of the present disclosure are described above with reference to the drawings. It may be understood that the above interaction interfaces are only schematic, and the corresponding interaction interfaces may be set according to requirements, which is not limited by the present disclosure.

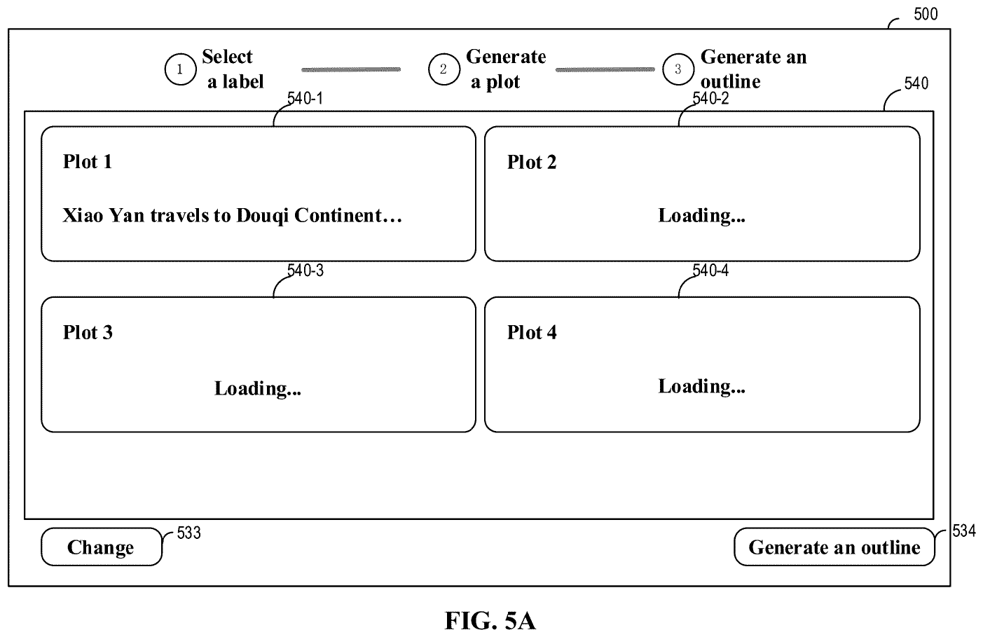

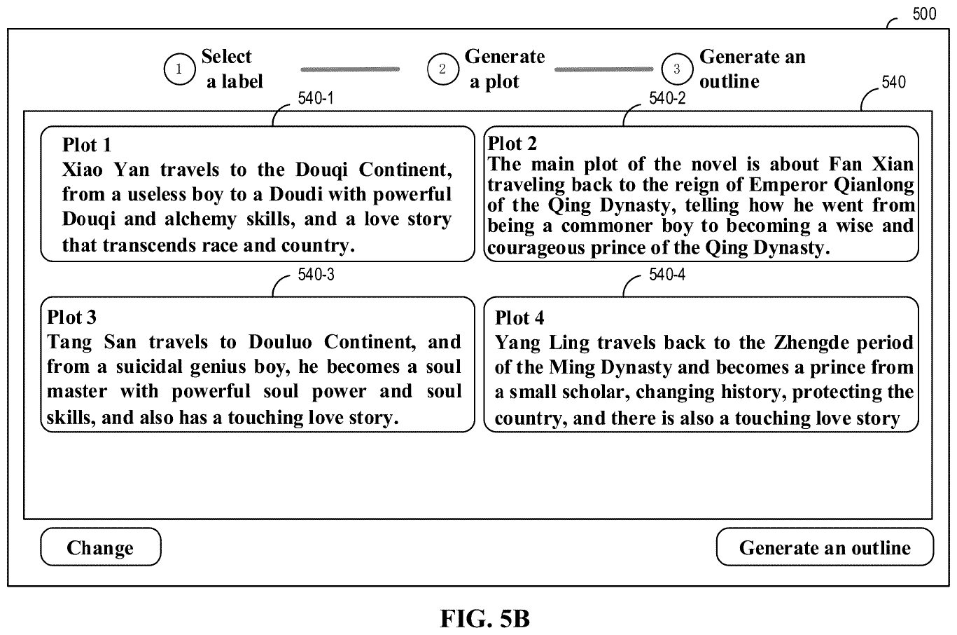

The exemplary user interaction for a plurality of summaries will be described below with reference to the drawings. FIG. 5A-FIG. 5B show schematic diagrams of an exemplary process of displaying content of one or more summaries to a user by the method for generating a novel outline according to an embodiment of the present disclosure. As shown in FIG. 5A-FIG. 5B, the summary area 540 of the interface 500 includes four text boxes for displaying the generated summaries, the text box 540-1 is used to display the content of a first summary, and the text box 540-2, the text box 540-3, and the text box 540-4 are used to display the content of the remaining summaries among the four summaries. As shown in FIG. 5A, in response to the generation of the plurality of summaries, the text box 540-1 gradually displays the content of the first summary in a streaming output manner, and at this time, the remaining text boxes each load the content of the remaining summaries to be displayed. As shown in FIG. 5B, in response to the content of the first summary being completely displayed in the text box 540-1, the remaining text boxes each display the loaded content corresponding to the remaining summaries. Therefore, the computing device only adopts the streaming output manner for the first summary to gradually display the content for the user, so that the operation of the user may be responded in a short time, and the waiting of the user may be reduced. Additionally, the content of the remaining summaries is loaded when the user browses the content of the first summary, and the entire content of the remaining summaries is displayed at one time when the content of the first summary is completely displayed, so that the loading of the remaining summaries is not easily perceived by the user, and the user experience is improved.

The exemplary training process of the copywriting outline model in the embodiment of the present disclosure will be described below schematically with reference to the drawings.

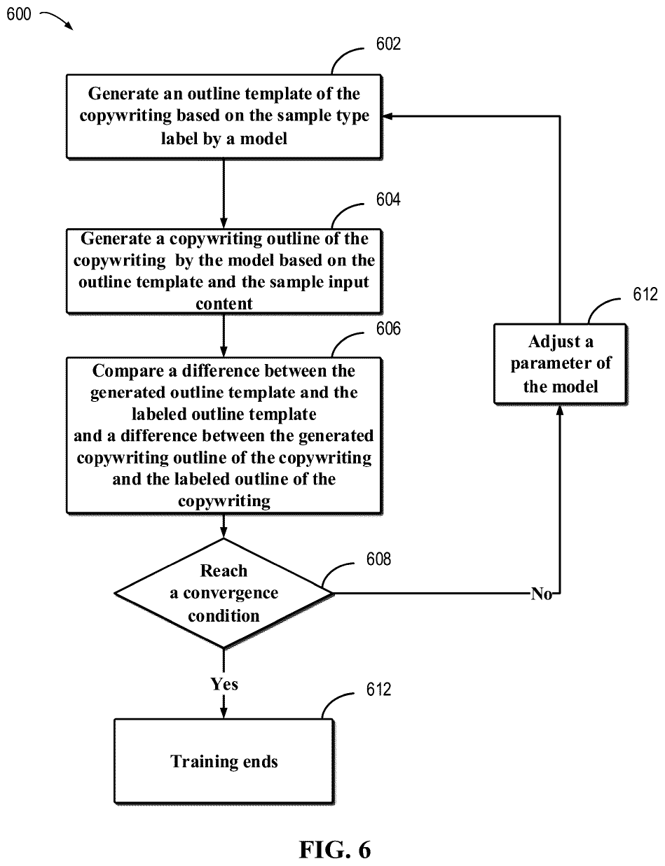

As shown in FIG. 6, in block 602, an outline template of a copywriting is generated by a model based on a sample type label. In some embodiments of the present disclosure, multiple groups of samples are usually prepared, and each group of samples includes a sample type label, sample input content, an annotated outline template, and an annotated copywriting outline. The annotated outline template corresponds to the annotation of the sample type label, and the annotated copywriting outline corresponds to the annotation of the annotated outline template and the sample input content. In some embodiments, a human writes the annotated outline template and the annotated copywriting outline that meet the description of the sample type label according to the description of the sample type label and the sample input content.

In block 604, a copywriting outline of the copywriting is generated by the model based on the outline template generated in block 602, the sample type label, and the sample input content. In some embodiments of the present disclosure, a summary may be randomly generated by the model based on the sample type label and the sample input content, and then, the copywriting outline of the copywriting is generated by the model based on the randomly generated summary and the outline template generated in block 602.

In block 606, the model is trained based on the generated outline template, the generated copywriting outline, the annotated outline template, and the annotated copywriting outline, and a loss value is calculated by comparing the difference between the annotated outline template and the generated outline template and the difference between the annotated copywriting outline and the generated copywriting outline.

In block 608, whether the model reaches a convergence condition is judged according to the calculated loss value. If the convergence condition is not reached, the process proceeds to block 612 to adjust the model, and after the adjustment is completed, the process returns to block 602 to continue the training. If the convergence condition is reached, the process proceeds to block 612, and the model training ends.

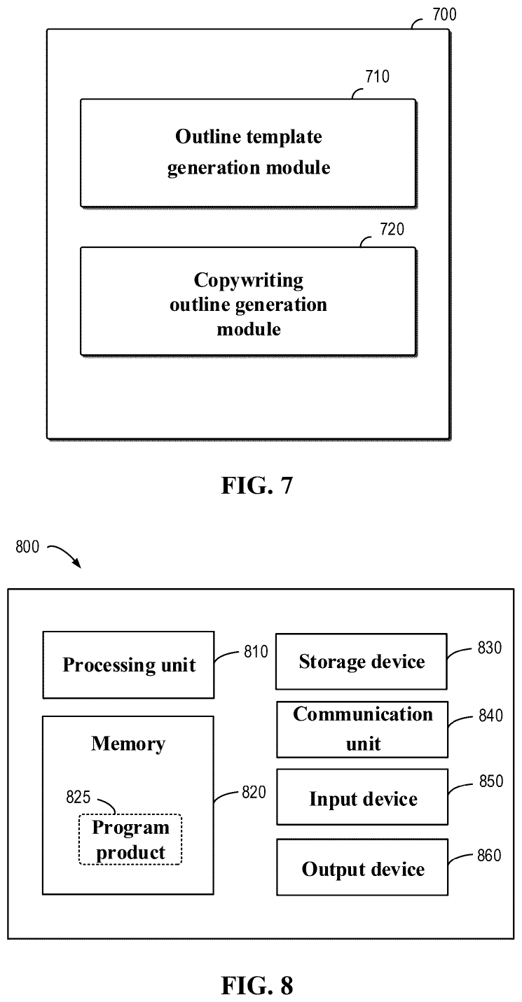

FIG. 7 shows a schematic block diagram of an example apparatus 700 according to some embodiments of the present disclosure. The apparatus 700 may be implemented by software, hardware, or a combination thereof. As shown in FIG. 7, the apparatus 700 includes an outline template generation module 710 and a copywriting outline generation module 720.

In some embodiments, the outline template generation module 710 may determine an outline template of a copywriting based on a type label of the copywriting. The copywriting outline generation module 720 may generate a copywriting outline of the copywriting based on the determined outline template and user input content. In some embodiments, the copywriting is a novel, and the outline template includes an outline module corresponding to the type label, for example, at least one of world view information, character information, and plot information.

The apparatus 700 in FIG. 7 may be used to implement the processes described above with reference to FIG. 1 to FIG. 6, which will not be repeated here for brevity.

The division of modules or units in the embodiments of the present disclosure is schematic, and is only a logical function division, and there may be other division manners in practical implementation. Additionally, functional units in the disclosed embodiments may be integrated into one unit, or may exist alone physically, or two or more units may be integrated into one unit. The above integrated units may be implemented in the form of hardware or software functional units.

FIG. 8 shows a block diagram of an example device 800 that may be used to implement the embodiments of the present disclosure. It should be understood that the device 800 shown in FIG. 8 is only an example, and should not constitute any limitation to the function and scope of the implementations described herein. For example, the device 800 may be used to invoke the model 620 corresponding to that described herein in conjunction with FIG. 1, and may be used to execute the processes described in FIG. 1 to FIG. 6 above.

As shown in FIG. 8, the device 800 is in the form of a general computing device. Components of the computing device 800 may include, but are not limited to, one or more processors or processing units 810, a memory 820, a storage device 830, one or more communication units 840, one or more input devices 850, and one or more output devices 860. The processing unit 810 may be an actual or virtual processor and may execute various processing according to a program stored in the memory 820. In a multi-processor system, a plurality of processing units execute computer-executable instructions in parallel to improve the parallel processing capability of the computing device 800.

The computing device 800 generally includes a plurality of computer storage media. Such medium may be any available medium accessible by the computing device 800, including but not limited to volatile and non-volatile media, removable and non-removable media. The memory 820 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. The storage device 830 may be a removable or non-removable medium, and may include a machine-readable medium, such as a flash drive, a magnetic disk, or any other medium, which may be used to store information and/or data (for example, training data for training) and may be accessed within the computing device 800.

The computing device 800 may further include additional removable/non-removable, volatile/non-volatile storage media. Although not shown in FIG. 8, a magnetic disk drive for reading from or writing to a removable, non-volatile magnetic disk (for example, a “floppy disk”) and an optical disk drive for reading from or writing to a removable, non-volatile optical disk may be provided. In these cases, each drive may be connected to the bus (not shown) by one or more data medium interfaces. The memory 820 may include a computer program product 825 having one or more program modules configured to perform various methods or actions of various implementations of the present disclosure.

The communication unit 840 enables communication with other computing devices through a communication medium. Additionally, the functions of the components of the computing device 800 may be implemented in a single computing cluster or multiple computing machines that may communicate through communication connections. Therefore, the computing device 800 may operate in a networked environment using a logical connection to one or more other servers, network personal computers (PCs), or another network node.

The input device 850 may be one or more input devices, such as a mouse, a keyboard, a trackball, etc. The output device 860 may be one or more output devices, such as a display, a speaker, a printer, etc. The computing device 800 may also communicate with one or more external devices (not shown), such as a storage device, a display device, etc., communicate with one or more devices that enable the user to interact with the computing device 800, or communicate with any device (for example, a network card, a modem, etc.) that enables the computing device 800 to communicate with one or more other computing devices, through the communication unit 840 as required. Such communication may be performed via an input/output (I/O) interface (not shown).

According to example implementations of the present disclosure, a computer-readable storage medium is provided, on which computer-executable instructions are stored, where the computer-executable instructions are executed by a processor to implement the method described above. According to example implementations of the present disclosure, a computer program product is further provided, the computer program product is tangibly stored on a non-transitory computer-readable medium and includes computer-executable instructions, and the computer-executable instructions are executed by a processor to implement the method described above. According to example implementations of the present disclosure, a computer program product is provided, on which a computer program is stored, and the program, when executed by a processor, implements the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, so that the instructions, when executed by the processing unit of the computer or other programmable data processing apparatus, produce an apparatus for implementing the functions/acts specified in one or more blocks of the flowcharts and/or block diagrams. These computer-readable program instructions may also be stored in a computer-readable storage medium, and these instructions cause the computer, programmable data processing apparatus, and/or other device to work in a specific manner, so that the computer-readable medium storing the instructions includes an article of manufacture, which includes instructions for implementing various aspects of the functions/acts specified in one or more blocks of the flowcharts and/or block diagrams.

The computer-readable program instructions may be loaded onto a computer, other programmable data processing apparatus, or other device to cause a series of operational steps to be performed on the computer, other programmable data processing apparatus, or other device to produce a computer-implemented process, such that the instructions executed on the computer, other programmable data processing apparatus, or other device implement the functions/acts specified in one or more blocks in the flowcharts and/or block diagrams.

The flowcharts and block diagrams in the drawings illustrate the architecture, functionality, and operation of possible implementations of systems, methods, and computer program products according to multiple implementations of the present disclosure. In this regard, each block in the flowcharts or block diagrams may represent a module, a program segment, or a portion of instructions, which includes one or more executable instructions for implementing specified logical functions. In some alternative implementations, the functions noted in the blocks may occur out of the order noted in the drawings. For example, two blocks shown in succession may, in fact, be executed substantially concurrently, or the blocks may sometimes be executed in a reverse order, depending upon the functionality involved. It is also noted that each block of the block diagrams and/or flowcharts, and combinations of blocks in the block diagrams and/or flowcharts, may be implemented by special-purpose hardware-based systems that perform the specified functions or acts, or combinations of special-purpose hardware and computer instructions.

Various implementations of the present disclosure have been described above, and the description is illustrative and not exhaustive, and is not limited to the disclosed implementations. Many modifications and variations will be apparent to those of ordinary skill in the art without departing from the scope and spirit of the described implementations. The terminology used herein was chosen to best explain the principles of the implementations, the practical application, or technical improvement over technologies in the market, or to enable others of ordinary skill in the art to understand the implementations disclosed herein.

I/We claim:

1. A method for generating a copywriting outline, comprising:
determining an outline template of a copywriting based on a type label of the copywriting, wherein the outline template comprises an outline module corresponding to the type label; and
generating a copywriting outline of the copywriting based on the determined outline template and user input content.

2. The method according to claim 1, wherein the type label comprises at least one of a first-level type label, a second-level type label corresponding to the first-level type label, and a third-level type label corresponding to the second-level type label, and the outline template comprises at least one of a first-level outline module corresponding to the first-level type label, a second-level outline module corresponding to the first-level outline module, and a third-level outline module corresponding to the third-level outline;
determining the outline template of the copywriting based on the type label of the copywriting comprises:
determining the first-level outline module of the outline template based on the first-level type label;
determining the second-level outline module of the first-level outline module determined by the first-level type label based on the second-level type label of the first-level type label; and
determining the third-level outline module of the second-level outline module determined by the second-level type label based on the third-level type label of the second-level type label.

3. The method according to claim 2, wherein the copywriting is a novel, the first-level outline module comprises at least one of world view information, character information, and plot information of the novel, the second-level outline module comprises at least one of a world background and a background event of the world view information, at least one of protagonist information, supporting role information, and villain information of the character information, and at least one of a main line plot, a branch line plot, a contradiction conflict, and chapter information of the plot information, the third-level outline module comprises at least one of a name, a gender, a character, an appearance, a character introduction, and a character relationship of the protagonist information, the supporting role information, and the villain information, and at least one of a chapter name, a chapter introduction, and one or more story introductions of the chapter information.

4. The method according to claim 1, wherein determining the outline template of the copywriting based on the type label of the copywriting comprises:
displaying a plurality of type labels, wherein the plurality of type labels comprise at least one of a first-level type label, a second-level type label, and a third-level type label;
determining one or more type labels of the copywriting from the plurality of type labels based on a selection of a user; and
generating the outline template by a model based on the determined one or more type labels.

5. The method according to claim 4, wherein generating the copywriting outline of the copywriting based on the determined outline template and the user input content comprises:
generating one or more summaries of the copywriting by the model based on the one or more type labels and the user input content;
determining a target summary from the one or more summaries based on a selection of the user; and
generating the copywriting outline of the copywriting by the model based on the outline template and the target summary.

6. The method according to claim 5, wherein generating the one or more summaries of the copywriting by the model based on the one or more type labels and the user input content comprises:
gradually displaying content of a first summary in a plurality of summaries to the user; and
displaying entire content of remaining summaries in the plurality of summaries in response to the content of the first summary being completely displayed.

7. The method according to claim 5, wherein generating the one or more summaries of the copywriting by the model based on the one or more type labels and the user input content comprises:
regenerating one or more new summaries of the copywriting based on the type label and the user input content in response to a user operation of regenerating the summaries.

8. The method according to claim 5, wherein generating the outline template by the model based on the one or more type labels comprises:
generating a first prompt for the model based on the one or more type labels; and
generating the outline template of the copywriting by the model based on the first prompt;
wherein generating the one or more summaries of the copywriting by the model based on the one or more type labels and the user input content comprises:
generating a second prompt for the model based on the one or more type labels and the user input content; and
generating the one or more summaries of the copywriting by the model based on the second prompt;
and wherein generating the copywriting outline of the copywriting by the model based on the outline template and the target summary comprises:
generating a third prompt for the model based on the outline template and the target summary; and
generating the copywriting outline of the copywriting by the model based on the third prompt.

9. The method according to claim 8, wherein training the model comprises:
generating an outline template of a copywriting by the model based on a sample type label, wherein the sample type label has a corresponding annotated outline template;
generating a copywriting outline of the copywriting by the model based on the generated outline template, the sample type label, and sample input content, wherein the annotated outline template and the sample input content have a corresponding annotated copywriting outline; and
training the model based on the generated outline template, the generated copywriting outline, the annotated outline template, and the annotated copywriting outline.

10. The method according to claim 1, further comprising:
presenting the generated copywriting outline; and
saving the generated copywriting outline in response to a saving operation of a user.

11. The method according to claim 1, further comprising:
generating a starting part of the copywriting based on the generated copywriting outline.

12. An electronic device, comprising:
at least one processing unit; and
at least one memory, the at least one memory being coupled to the at least one processing unit and stores instructions configured to be executed by the at least one processing unit, the instructions, when executed by the at least one processing unit, causing the electronic device to:
determine an outline template of a copywriting based on a type label of the copywriting, wherein the outline template comprises an outline module corresponding to the type label; and
generate a copywriting outline of the copywriting based on the determined outline template and user input content.

13. The device according to claim 12, wherein the type label comprises at least one of a first-level type label, a second-level type label corresponding to the first-level type label, and a third-level type label corresponding to the second-level type label, and the outline template comprises at least one of a first-level outline module corresponding to the first-level type label, a second-level outline module corresponding to the first-level outline module, and a third-level outline module corresponding to the third-level outline;
the instructions causing the device to determine the outline template of the copywriting based on the type label of the copywriting comprise instructions causing the device to:
determine the first-level outline module of the outline template based on the first-level type label;
determine the second-level outline module of the first-level outline module determined by the first-level type label based on the second-level type label of the first-level type label; and
determine the third-level outline module of the second-level outline module determined by the second-level type label based on the third-level type label of the second-level type label.

14. The device according to claim 13, wherein the copywriting is a novel, the first-level outline module comprises at least one of world view information, character information, and plot information of the novel, the second-level outline module comprises at least one of a world background and a background event of the world view information, at least one of protagonist information, supporting role information, and villain information of the character information, and at least one of a main line plot, a branch line plot, a contradiction conflict, and chapter information of the plot information, the third-level outline module comprises at least one of a name, a gender, a character, an appearance, a character introduction, and a character relationship of the protagonist information, the supporting role information, and the villain information, and at least one of a chapter name, a chapter introduction, and one or more story introductions of the chapter information.

15. The device according to claim 12, wherein the instructions causing the device to determine the outline template of the copywriting based on the type label of the copywriting comprise instructions causing the device to:
display a plurality of type labels, wherein the plurality of type labels comprise at least one of a first-level type label, a second-level type label, and a third-level type label;
determine one or more type labels of the copywriting from the plurality of type labels based on a selection of a user; and
generate the outline template by a model based on the determined one or more type labels.

16. The device according to claim 15, wherein the instructions causing the device to generate the copywriting outline of the copywriting based on the determined outline template and the user input content comprise instructions causing the device to:
generate one or more summaries of the copywriting by the model based on the one or more type labels and the user input content;
determine a target summary from the one or more summaries based on a selection of the user; and
generate the copywriting outline of the copywriting by the model based on the outline template and the target summary.

17. The device according to claim 16, wherein the instructions causing the device to generate the one or more summaries of the copywriting by the model based on the one or more type labels and the user input content comprise instructions causing the device to:
gradually display content of a first summary in a plurality of summaries to the user; and
display entire content of remaining summaries in the plurality of summaries in response to the content of the first summary being completely displayed.

18. The device according to claim 17, wherein the instructions causing the device to generate the one or more summaries of the copywriting by the model based on the one or more type labels and the user input content comprise instructions causing the device to:
regenerate one or more new summaries of the copywriting based on the type label and the user input content in response to a user operation of regenerating the summaries.

19. The device according to claim 12, the device is further caused to:
present the generated copywriting outline; and
save the generated copywriting outline in response to a saving operation of a user.

20. A non-transitory computer-readable storage medium, on which a computer program is stored, and the computer program, when executed by a processor, causes the processor to:
determine an outline template of a copywriting based on a type label of the copywriting, wherein the outline template comprises an outline module corresponding to the type label; and
generate a copywriting outline of the copywriting based on the determined outline template and user input content.
